(19) United States
(12) Patent Application Publication
(10) Pub. No.: US 2014/0254169 A1
(43) Pub. Date: Sep. 11, 2014

(54) ILLUMINATION DEVICE AND ILLUMINATION UNIT

(71) Applicant: Kabushiki Kaisha Toshiba, Minato-ku (JP)

(72) Inventor: Michinobu INOUE, Kanagawa-ken (JP)

(73) Assignee: Kabushiki Kaisha Toshiba, Minato-ku (JP)

(21) Appl. No.: 14/191,799

(22) Filed: Feb. 27, 2014

(30) Foreign Application Priority Data
Mar. 6, 2013 (JP) 2013-044566

(51) Int. Cl. F21K 99/00

(52) U.S. Cl. CPC F21K 9/50
USPC 362/296.01; 362/311.02

(57) ABSTRACT

According to one embodiment, an illumination device includes a first light-transmissive member, a first chassis, and a first semiconductor light emitting unit. The first light-transmissive member has first and second member ends. The first chassis includes a first base portion, first and second side portions. The first base portion is separated from the first light-transmissive member and has first and second base ends. The first side portion extends from the first base end toward the first member end and has first and second end portions. The second side portion extends from the second base end toward the second member end and has third and fourth end portions. A distance between the first and third end portions is shorter than a distance between the second and fourth end portions. The first semiconductor light emitting unit is provided between the first and second side portions.

### CROSS-REFERENCE TO RELATED APPLICATIONS

This application is based upon and claims the benefit of priority from Japanese Patent Application No. 2013-044566, filed on Mar. 6, 2013; the entire contents of which are incorporated herein by reference.

### FIELD

Embodiments described herein relate generally to an illumination device and an illumination unit.

### BACKGROUND

Illumination devices and illumination units are widely utilized. It is desirable for such illumination devices and illumination units to emit light uniformly without dark portions in the light emitting surface.

### BRIEF DESCRIPTION OF THE DRAWINGS

FIG. 1A to FIG. 1C are schematic views showing an illumination device according to a first embodiment;

FIG. 2 is a perspective view showing an illumination unit according to the first embodiment;

FIG. 3A and FIG. 3B are schematic cross-sectional views showing illumination units according to the first embodiment;

FIG. 4A and FIG. 4B are schematic cross-sectional views showing illumination units according to the first embodiment;

FIG. 5 is a perspective view showing an illumination unit according to the first embodiment;

FIG. 6 is a schematic cross-sectional view showing an illumination device according to a second embodiment; and

FIG. 7 is a schematic cross-sectional view showing an illumination unit according to the second embodiment.

### DETAILED DESCRIPTION

According to one embodiment, an illumination device includes a first light-transmissive member, a first chassis, and a first semiconductor light emitting unit. The first light-transmissive member has a first member end and a second member end, the second member end being separated from the first member end in a first direction. The first chassis includes a first base portion, a first side portion, and a second side portion. The first base portion is separated from the first light-transmissive member in a second direction intersecting the first direction. The first base portion has a first base end and a second base end, the second base end being separated from the first base end in the first direction. The first side portion extends from the first base end toward the first member end. The first side portion has a first end portion and a second end portion, the first end portion being connected to the first base end, the second end portion being on a side of the first member end. The second side portion extends from the second base end toward the second member end. The second side portion has a third end portion and a fourth end portion, the third end portion being connected to the second base end, the fourth end portion being on a side of the second member end. A distance along the first direction between the first end portion and the third end portion is shorter than a distance along the first direction between the second end portion and the fourth end portion. The first semiconductor light emitting unit is provided between the first side portion and the second side portion in a space between the first light-transmissive member and the first base portion.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

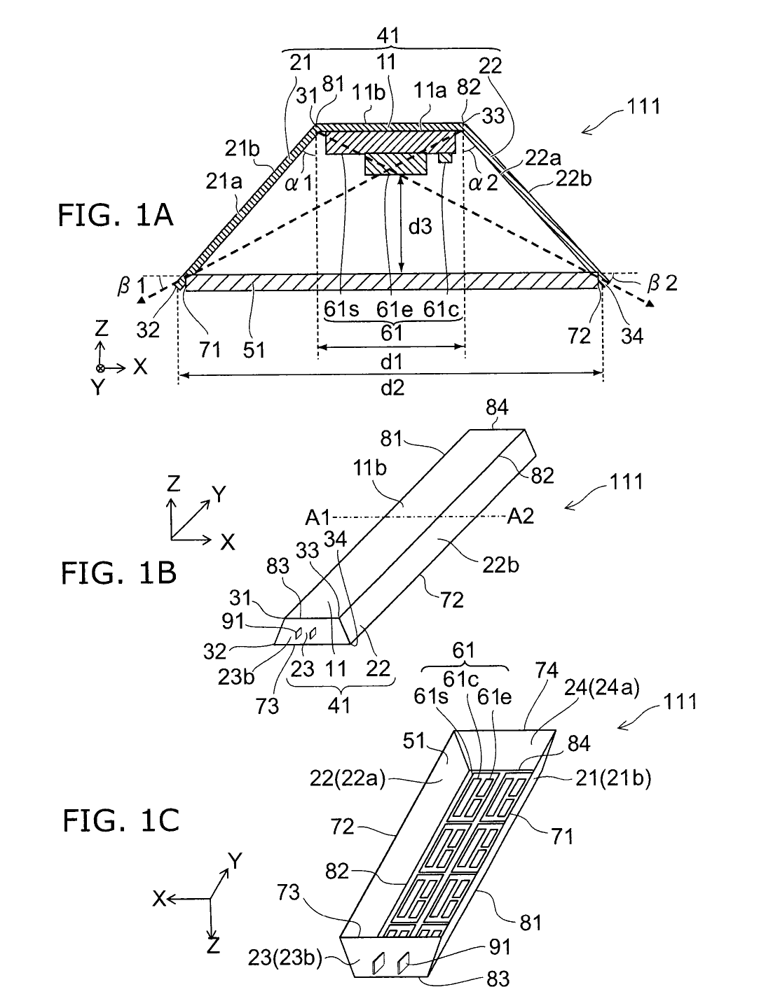

FIG. 1A to FIG. 1C are schematic views illustrating an illumination device according to a first embodiment. FIG. 1B is a perspective view showing an example of the illumination device 111. FIG. 1C is a perspective view showing the example of the illumination device 111. In FIG. 1C, the directions of up and down are inverted from those of FIG. 1B. FIG. 1A is a schematic cross-sectional view that shows the example of the illumination device 111 and corresponds to the cross-sectional view along line A1-A2 of FIG. 1B.

As shown in FIGS. 1A to 1C, the illumination device 111 (a first illumination device) includes a light-transmissive member 51 (a first light-transmissive member), a chassis 41 (a first chassis), and a semiconductor light emitting unit 61 (a first semiconductor light emitting unit).

The light-transmissive member 51 has a first member end 71 and a second member end 72. The second member end 72 is separated from the first member end 71 in a first direction (e.g., an X-axis direction).

In the specification of the application, the direction from the first member end 71 toward the second member end 72 is taken as the first direction (the X-axis direction). One direction orthogonal to the first direction (the X-axis direction) is taken as a Z-axis direction. A direction orthogonal to the X-axis direction and the Z-axis direction is taken as a Y-axis direction.

The chassis 41 includes a base portion 11 (a first base portion), a first side portion 21, and a second side portion 22.

The base portion 11 is separated from the light-transmissive member 51 in a second direction (e.g., the Z-axis direction) intersecting the first direction. The base portion 11 has a first base end 81 and a second base end 82. The second base end 82 is separated from the first base end 81 in the first direction.

The first base end 81 extends, for example, along a third direction. The second base end 82 extends, for example, along the third direction. The third direction is a direction (e.g., the Y-axis direction) that intersects the first direction and intersects the second direction.

The base portion 11 further has, for example, a third base end 83 and a fourth base end 84. The third base end 83 is connected to, for example, one end of the first base end 81 and one end of the second base end 82. For example, the fourth base end 84 is separated from the third base end 83 in the third direction. The fourth base end 84 is connected to, for example, the other end of the first base end 81 and the other end of the second base end 82.

The configuration of the base portion 11 is, for example, a rectangle. In the example, the base portion 11 is a rectangle having the first base end 81 and the second base end 82 as long sides and the third base end 83 and the fourth base end 84 as short sides. The configuration of the base portion 11 may be, for example, a polygon other than a rectangle.

The base portion 11 is provided to oppose, for example, the light-transmissive member 51. The base portion 11 has a first major surface 11a and a second major surface 11b. The first major surface 11a is a surface opposing, for example, the light-transmissive member 51. The second major surface 11b is the surface on the side opposite to the first major surface 11a.

In the specification of the application, the state of being “opposed” includes not only the state of directly facing each other but also the state in which another component is inserted therebetween.

The first side portion 21 extends from the first base end 81 toward the first member end 71. For example, the first side portion 21 is connected to the base portion 11 and extends toward the light-transmissive member 51. The first side portion 21 has a first end portion 31 and a second end portion 32. The first end portion 31 of the first side portion 21 is connected to the first base end 81. The second end portion 32 of the first side portion 21 is disposed on the first member end 71 side.

The first end portion 31 of the first side portion 21 extends along, for example, the third direction (the Y-axis direction). The second end portion 32 extends along, for example, the third direction (the Y-axis direction).

The configuration of the first side portion 21 is, for example, a rectangle. In the example, the first side portion 21 is a rectangle having the first end portion 31 and the second end portion 32 as long sides. The configuration of the first side portion 21 may be, for example, a polygon other than a rectangle.

The first side portion 21 has, for example, a first inner surface 21a and a first outer surface 21b. The first inner surface 21a is a surface on the second side portion 22 side. The first outer surface 21b is the surface on the side opposite to the first inner surface 21a.

The second side portion 22 extends from the second base end 82 toward the second member end 72. For example, the second side portion 22 is separated from the first side portion 21 in the first direction. For example, the second side portion 22 is connected to the base portion 11 and extends toward the light-transmissive member 51. The second side portion 22 has a third end portion 33 and a fourth end portion 34. The third end portion 33 of the second side portion 22 is connected to the second base end 82. The fourth end portion 34 of the second side portion 22 is disposed on the second member end 72 side.

The third end portion 33 of the second side portion 22 extends along, for example, the third direction (the Y-axis direction). The fourth end portion 34 extends along, for example, the third direction (the Y-axis direction).

The configuration of the second side portion 22 is, for example, a rectangle. In the example, the second side portion 22 is a rectangle having the third end portion 33 and the fourth end portion 34 as long sides. The configuration of the second side portion may be, for example, a polygon other than a rectangle.

The second side portion 22 has, for example, a second inner surface 22a and a second outer surface 22b. The second inner surface 22a is a surface on the first side portion 21 side. The second outer surface 22b is the surface on the side opposite to the second inner surface 22a.

In the chassis 41, the distance (a first distance d1) along the first direction between the first end portion 31 and the third end portion 33 is shorter than the distance (a second distance d2) along the first direction between the second end portion 32 and the fourth end portion 34.

When projected onto a first plane (in the example, the X-Z plane) including the first direction and the second direction, an angle α1 between the second direction and the line segment connecting the first end portion 31 to the second end portion 32 is, for example, more than 0 degrees but less than 90 degrees. When projected onto the first plane, an angle α2 between the second direction and the line segment connecting the third end portion 33 to the fourth end portion 34 is, for example, more than 0 degrees but less than 90 degrees.

The angle α1 and the angle α2 may be the same angle or different angles. For example, the first plane is perpendicular to the third direction.

The light-transmissive member 51 further has, for example, a third member end 73 and a fourth member end 74. The third member end 73 is connected to, for example, one end of the first member end 71 and one end of the second member end 72. For example, the fourth member end 74 is separated from the third member end 73 in the third direction (the Y-axis direction). The fourth member end 74 is connected to, for example, the other end of the first member end 71 and the other end of the second member end 72.

The configuration of the light-transmissive member 51 is, for example, a rectangle. In the example, the light-transmissive member 51 is a rectangle having the first member end 71 and the second member end 72 as long sides and the third member end 73 and the fourth member end 74 as short sides. The configuration of the light-transmissive member 51 may be, for example, a polygon other than a rectangle.

As shown in FIG. 1A, when projected onto a plane (e.g., the first plane) perpendicular to the third direction, the configuration of the illumination device 111 is, for example, a trapezoid including the base portion 11, the first side portion 21, the second side portion 22, and the light-transmissive member 51.

The chassis 41 has an inner surface and an outer surface. The inner surface includes, for example, the first inner surface 21a, the second inner surface 22a, and the first major surface 11a. The outer surface includes, for example, the first outer surface 21b, the second outer surface 22b, and the second major surface 11b.

The semiconductor light emitting unit 61 is provided between the first side portion 21 and the second side portion 22 in the space between the light-transmissive member 51 and the base portion 11. The semiconductor light emitting unit 61 is provided, for example, on the first major surface 11a of the base portion 11. The semiconductor light emitting unit 61 contacts, for example, the base portion 11.

In the specification of the application, the state of being “provided on” includes not only the state of being provided in direct contact but also the state in which another layer is inserted therebetween.

The semiconductor light emitting unit 61 includes, for example, a substrate 61s and a semiconductor light emitting element 61e. The substrate 61s is provided, for example, on the first major surface 11a. The substrate 61s includes, for example, a glass epoxy substrate, an aluminum substrate, an iron substrate, or an alumina ceramic substrate.

The semiconductor light emitting element 61e is provided, for example, on the substrate 61s. In the example, multiple semiconductor light emitting elements 61e are provided on the substrate 61s. The number of the semiconductor light emitting elements 61e is arbitrary. The semiconductor light emitting element 61e includes, for example, a light emitting diode (LED).

In the example, the semiconductor light emitting unit 61 further includes a circuit unit 61c. The circuit unit 61c is electrically connected to, for example, the semiconductor light emitting element 61e. For example, a current or a voltage is supplied to the semiconductor light emitting element 61e via the circuit unit 61c. Thereby, light is emitted from the semiconductor light emitting element 61e.

A circuit substrate that includes the circuit unit 61c may be used as the substrate 61s.

The light from the semiconductor light emitting unit 61 is emitted, for example, isotropically. On the other hand, the first side portion 21 and the second side portion 22 open out from the base portion 11 side toward the light-transmissive member 51 side. Therefore, the light emitted from the semiconductor light emitting unit 61 is reflected by the inner surface of the chassis 41 (e.g., the first inner surface 21a, the second inner surface 22a, and the first major surface 11a) to be diffused uniformly on the light-transmissive member 51 side. Then, the light that is diffused uniformly is emitted to the outside via the light-transmissive member 51. A uniform light emission is obtained in the illumination device 111. The light-transmissive member 51 is used as the light emitting surface.

In the case where the number of reflections of the light by the first side portion 21 and the second side portion 22 is large, for example, the luminous efficiency of the illumination device 111 may decrease due to the increase of the absorption amount of the light. On the other hand, in the case where the number of reflections is small, for example, the diffusion of the light may be insufficient; and a uniform light emission may not be obtained. The angle α1 between the base portion 11 and the first side portion 21 is set to be, for example, not less than 45 degrees and not more than 75 degrees. The angle α2 between the base portion 11 and the second side portion 22 is set to be, for example, not less than 45 degrees and not more than 75 degrees. Thereby, the number of reflections at the inner surface of the chassis 41 can be set appropriately.

Also, in the case where a third distance d3 between the semiconductor light emitting unit 61 (the semiconductor light emitting element 61e) and the light-transmissive member 51 is short, the number of reflections of the light may decrease; and a uniform light emission may not be obtained. The third distance d3 is, for example, not less than 1 cm and not more than 10 cm.

In the illumination device 111, the light emitting surface can be larger because the first side portion 21 and the second side portion 22 open out from the base portion 11 toward the light-transmissive member 51.

When projected onto the plane (e.g., the first plane) perpendicular to the third direction (the Y-axis direction), an angle β1 between the first direction and the line segment connecting the second end portion 32 to the third end portion 33 is, for example, not less than 15 degrees and not more than 45 degrees.

When projected onto the plane perpendicular to the third direction (the Y-axis direction), an angle β2 between the first direction and the line segment connecting the first end portion 31 to the fourth end portion 34 is, for example, not less than 15 degrees and not more than 45 degrees.

The angle β1 and the angle β2 may be the same angle or different angles.

In the case where the angle β1 and the angle β2 of the chassis 41 are set to be within these ranges, the light from the semiconductor light emitting unit 61 is shielded effectively by, for example, the first side portion 21 and the second side portion 22. Appropriate light shielding can be obtained by the chassis 41; and, for example, even in the case where the illumination device 111 is viewed from an oblique direction, the light from the semiconductor light emitting unit 61 that directly enters the eyes is suppressed. Glare can be suppressed.

The chassis 41 (e.g., the base portion 11, the first side portion 21, and the second side portion 22) includes, for example, a metal. The metal may have high heat dissipation. The chassis 41 includes, for example, an aluminum alloy or steel. The chassis 41 includes, for example, a steel plate, an aluminum plate, etc. The base portion 11, the first side portion 21, and the second side portion 22 of the chassis 41 may include the same material or different materials.

The light-transmissive member 51 includes, for example, a plastic plate that is light-transmissive or a glass plate. The light-transmissive member 51 may include, for example, a polycarbonate plate, an acrylic plate, or the like, that is light-transmissive.

For example, the reflectance of at least a portion of the first inner surface 21a of the first side portion 21 is higher than the reflectance of the light-transmissive member 51. For example, the reflectance of at least a portion of the second inner surface 22a of the second side portion 22 is higher than the reflectance of the light-transmissive member 51. Thereby, the loss of the light due to the reflections at the first side portion 21 and the second side portion 22 can be suppressed; and the light extraction efficiency can be increased. The optical reflectance of at least a portion of the first major surface 11a of the base portion 11, e.g., a portion other than the region of the first major surface 11a where the semiconductor light emitting unit 61 is disposed, may be set to be higher than the reflectance of the light-transmissive member 51.

For example, a reflective layer may be provided on at least a portion of the first inner surface 21a, at least a portion of the second inner surface 22a, and/or at least a portion of the first major surface 11a. The reflective layer is formed by, for example, coating a first coating. It is favorable for the first coating to have tolerance to the heat generated in the semiconductor light emitting unit 61. Also, it is favorable for the first coating to have tolerance to the light from the semiconductor light emitting unit 61. The first coating may include, for example, a white coating.

The white coating includes at least one type of white pigment and at least one type of resin. The white pigment may include, for example, titanium oxide (TiO₂), zinc oxide (ZnO), barium sulfate (BaSO₄), magnesium oxide (MgO), etc. It is favorable for the resin to include, for example, a polyester resin or a silicone resin. The resin may include, for example, an acrylic resin, an epoxy resin, a urethane resin, etc.

For example, the thermal conductivity of the chassis 41 is higher than the thermal conductivity of the light-transmissive member 51. For example, the emissivity of at least a portion of the first outer surface 21b of the first side portion 21 is higher than the emissivity of the light-transmissive member 51. For example, the emissivity of at least a portion of the second outer surface 22b of the second side portion 22 is higher than the emissivity of the light-transmissive member 51. Thereby, the heat dissipation of the chassis 41 can be improved; and the temperature increase of the semiconductor light emitting unit 61 can be suppressed. The emissivity of at least a portion of the second major surface 11b of the base portion 11 which is a third outer surface may be set to be higher than the emissivity of the light-transmissive member 51.

For example, a heat radiation layer may be provided on at least a portion of the first outer surface 21b, at least a portion of the second outer surface 22b, and/or at least a portion of the second major surface 11b. The heat radiation layer is formed by, for example, coating a second coating. The second coating may include, for example, an organic coating that is based on a silicone resin, a urethane resin, a polyester resin, etc. An additive may be added to such coatings. The additive may have a high emissivity. For example, a ceramic filler, etc., may be used as the additive. The ceramic filler may include, for example, alumina (Al₂O₃), etc. The first coating and the second coating may be different coatings or the same coating.

For example, an oxide film may be provided as the heat radiation layer on at least a portion of the first outer surface 21b and/or at least a portion of the second outer surface 22b. The oxide film may be formed by, for example, performing surface treatment (e.g., anodic oxidation of aluminum) of the first outer surface 21b or the second outer surface 22b.

For example, the luminous efficiency of the semiconductor light emitting element 61e decreases when the temperature of the semiconductor light emitting unit 61 increases. Moreover, when the temperature of the semiconductor light emitting unit 61 increases during use, the power provided to the semiconductor light emitting unit 61 cannot be increased; and it is difficult to increase the light emission output.

The luminous efficiency can be increased by increasing the thermal conductivity or emissivity of the chassis 41 and improving the heat dissipation of the chassis 41.

In the example as shown in FIG. 1B and FIG. 1C, the chassis 41 further includes a third side portion 23 and a fourth side portion 24. For example, the semiconductor light emitting unit 61 is provided between the third side portion 23 and the fourth side portion 24.

For example, the third side portion 23 is provided between the third base end 83 and the third member end 73. The third side portion 23 intersects the third direction (the Y-axis direction). For example, the third side portion 23 is orthogonal to the third direction.

For example, the fourth side portion 24 is provided between the fourth base end 84 and the fourth member end 74. The fourth side portion 24 intersects the third direction (the Y-axis direction). For example, the fourth side portion 24 is orthogonal to the third direction.

The third side portion 23 is connected to, for example, at least one selected from the base portion 11, the first side portion 21, and the second side portion 22. The fourth side portion 24 is connected to, for example, at least one selected from the base portion 11, the first side portion 21, and the second side portion 22.

In the example as shown in FIG. 1B and FIG. 1C, the third side portion 23 is connected to the base portion 11 (the third base end 83), the first side portion 21, and the second side portion 22. The fourth side portion 24 is connected to the base portion 11 (the fourth base end 84), the first side portion 21, and the second side portion 22. In the example, the configuration of the third side portion 23 and the configuration of the fourth side portion 24 are trapezoids. The configuration of the third side portion 23 and the configuration of the fourth side portion 24 are arbitrary.

The light-transmissive member 51 is connected to the first side portion 21, the second side portion 22, the third side portion 23, and the fourth side portion 24. In other words, the semiconductor light emitting unit 61 is covered with the base portion 11, the first side portion 21, the second side portion 22, the third side portion 23, the fourth side portion 24, and the light-transmissive member 51. Therefore, for example, the penetration of foreign matter, etc., into the semiconductor light emitting unit 61 can be suppressed. Also, mistaken contact with the semiconductor light emitting unit 61 can be prevented when the illumination device 111 is mounted.

In such a case, it is favorable to provide an opening in at least one location between the first side portion 21 and the third side portion 23, between the base portion 11 and the third side portion 23, between the second side portion 22 and the third side portion 23, between the light-transmissive member 51 and the third side portion 23, between the first side portion 21 and the fourth side portion 24, between the base portion 11 and the fourth side portion 24, between the second side portion and the fourth side portion 24, and/or between the light-transmissive member 51 and the fourth side portion 24. The heat from the semiconductor light emitting unit 61 can be emitted to the outside via the opening.

In the example as shown in FIG. 1C, the illumination device 111 further includes a connection terminal 91 (a first connection terminal). For example, the connection terminal 91 pierces the third side portion 23 in the third direction. The connection terminal 91 may be provided, for example, in the fourth side portion 24. In such a case, for example, the connection terminal 91 pierces the fourth side portion 24 in the third direction. The connection terminal 91 may be provided in both the third side portion 23 and the fourth side portion 24. The number of the connection terminals 91 is arbitrary.

The connection terminal 91 includes, for example, a metal. For example, it is favorable for the metal to have high electrical conductivity. The connection terminal 91 may include, for example, at least one selected from copper and aluminum, or an alloy including at least one selected from copper and aluminum. The surface of the connection terminal 91 may be plated. The plating may include, for example, tin plating, gold plating, etc.

The configuration of the connection terminal 91 is arbitrary. For example, the connection terminal 91 has a protruding configuration.

The connection terminal 91 is electrically connected to, for example, the semiconductor light emitting unit 61. The connection terminal 91 functions as, for example, an electrode for supplying power to the semiconductor light emitting unit 61.

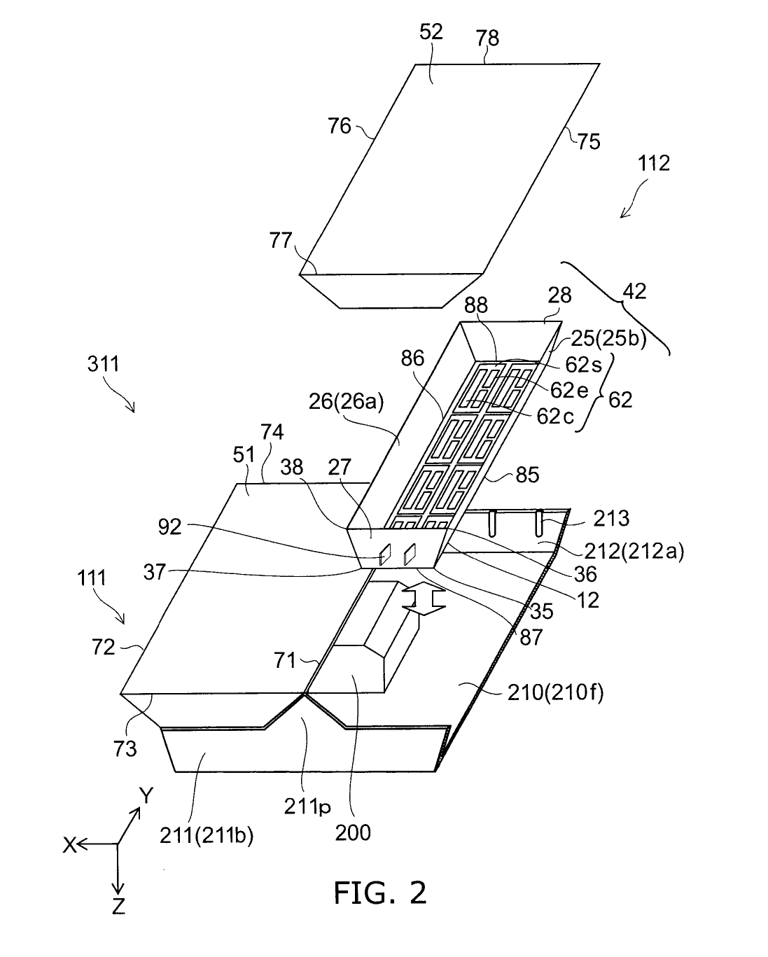

FIG. 2 is a perspective view illustrating an illumination unit according to the first embodiment.

As shown in FIG. 2, the illumination unit 311 includes the first illumination device 111, a second illumination device 112, a controller 200, and a holder 210. In the example, the illumination unit 311 includes two illumination devices (the first illumination device 111 and the second illumination device 112). The illumination device described in regard to FIG. 1A to FIG. 1B may be used as the first illumination device 111 and the second illumination device 112.

Namely, the second illumination device 112 includes a second light-transmissive member 52, a second chassis 42, and a second semiconductor light emitting unit 62. The second light-transmissive member 52 has a fifth member end 75 and a sixth member end 76. The sixth member end 76 is separated from the fifth member end 75 in the first direction. In the example, the second light-transmissive member 52 further has a seventh member end 77 and an eighth member end 78. The seventh member end 77 is connected to, for example, one end of the fifth member end 75 and one end of the sixth member end 76. For example, the eighth member end 78 is separated from the seventh member end 77 in the third direction. The eighth member end 78 is connected to, for example, the other end of the fifth member end 75 and the other end of the sixth member end 76.

The second chassis 42 includes a second base portion 12, the third side portion 23, and the fourth side portion 24. The second base portion 12 is separated from the second light-transmissive member 52 in the second direction (the Z-axis direction). The second base portion 12 has a fifth base end 85 and a sixth base end 86. The sixth base end 86 is separated from the fifth base end 85 in the first direction.

The fifth base end 85 extends along, for example, the third direction (the Y-axis direction). The sixth base end 86 extends along, for example, the third direction (the Y-axis direction).

For example, the second base portion 12 further has a seventh base end 87 and an eighth base end 88. The seventh base end 87 is connected to, for example, one end of the fifth base end 85 and one end of the sixth base end 86. The eighth base end 88 is connected to, for example, the other end of the fifth base end 85 and the other end of the sixth base end 86.

A fifth side portion 25 extends from the fifth base end 85 toward the fifth member end 75. For example, the fifth side portion 25 is connected to the second base portion 12 and extends toward the second light-transmissive member 52. The fifth side portion 25 has a fifth end portion 35 and a sixth end portion 36. The fifth end portion 35 of the fifth side portion 25 is connected to the fifth base end 85. The sixth end portion 36 of the fifth side portion 25 is disposed on the fifth member end 75 side.

A sixth side portion 26 extends from the sixth base end 86 toward the sixth member end 76. For example, the sixth side portion 26 is separated from the fifth side portion 25 in the first direction. For example, the sixth side portion 26 is connected to the second base portion 12 and extends toward the second light-transmissive member 52. The sixth side portion 26 has a seventh end portion 37 and an eighth end portion 38. The seventh end portion 37 of the sixth side portion 26 is connected to the sixth base end 86. The eighth end portion 38 of the sixth side portion 26 is disposed on the sixth member end 76 side.

The distance along the first direction between the fifth end portion 35 and the seventh end portion 37 of the second chassis 42 is shorter than the distance along the first direction between the sixth end portion 36 and the eighth end portion 38 of the second chassis 42.

The second semiconductor light emitting unit 62 is provided between the fifth side portion 25 and the sixth side portion 26 in the space between the second light-transmissive member 52 and the second base portion 12. The second semiconductor light emitting unit 62 includes, for example, a second substrate 62s, a second semiconductor light emitting element 62e, and a second circuit unit 62c.

In the example, the second illumination device 112 further includes a seventh side portion 27, an eighth side portion 28, and a second connection terminal 92. For example, the seventh side portion 27 is provided between the seventh base end 87 and the seventh member end 77. The seventh side portion 27 intersects the third direction. The seventh side portion 27 is connected to, for example, the second base portion 12, the fifth side portion 25, and the sixth side portion 26. For example, the eighth side portion 28 is provided between the eighth base end 88 and the eighth member end 78. The eighth side portion 28 intersects the third direction. The eighth side portion 28 is connected to, for example, the second base portion 12, the fifth side portion 25, and the sixth side portion 26. For example, the second connection terminal 92 pierces the seventh side portion 27 in the third direction. For example, the second connection terminal 92 may be provided at the eighth side portion 28.

The holder 210 has, for example, a holding surface 210f, a first side surface 211, and a second side surface 212. The first side surface 211 is connected to, for example, the holding surface 210f. For example, the first side surface 211 is non-parallel to the holding surface 210f. The first side surface 211 has, for example, a first inner surface 211a and a first outer surface 211b. The first inner surface 211a is the surface on the holding surface 210f side. The first outer surface 211b is the surface on the side opposite to the first inner surface 211a.

For example, the second side surface 212 is separated from the first side surface 211 in the third direction (the Y-axis direction). The second side surface 212 is connected to, for example, the holding surface 210f. For example, the second side surface 212 is non-parallel to the holding surface 210f. For example, the second side surface 212 opposes the first side surface 211. The second side surface 212 has, for example, a second inner surface 212a and a second outer surface 212b. The second inner surface 212a is the surface on the holding surface 210f side. The second outer surface 212b is the surface on the side opposite to the second inner surface 212a.

The holder 210 holds the first illumination device 111 and the second illumination device 112. The first illumination device 111 and the second illumination device 112 are held, for example, on the holding surface 210f.

In the example, the first base portion (the base portion 11) of the first illumination device 111 is held by the holding surface 210f; and the second base portion 12 of the second illumination device 112 is held in the holding surface 210f. In such a case, for example, the sixth base end 86 is disposed between the second base end 82 and the fifth base end 85. For example, the sixth base end 86 is disposed between the first base end 81 and the fifth base end 85. In other words, in the example, the first illumination device 111 and the second illumination device 112 are disposed such that the long side of the second base portion 12 having the rectangular configuration opposes the long side of the first base portion 11 having the rectangular configuration.

For example, the third side portion 23 of the first illumination device 111 opposes the first side surface 211; and the fourth side portion 24 of the first illumination device 111 opposes the second side surface 212. The seventh side portion 27 of the second illumination device 112 opposes the first side surface 211; and the eighth side portion 28 of the second illumination device 112 opposes the second side surface 212. In such a case, the first illumination device 111 and the second illumination device 112 may be disposed such that the gap between the first light-transmissive member 51 and the second light-transmissive member 52 becomes small. Thereby, a uniform light emission is obtained over the entire region of the illumination unit 311. Considering the heat dissipation, a very small gap may be provided between the first light-transmissive member 51 and the second light-transmissive member 52. The gap is described below.

The controller 200 is provided, for example, between the first illumination device 111 and the second illumination device 112. The controller 200 is provided, for example, in the space defined by the first side portion 21, the sixth side portion 26, and the holding surface 210f. The controller 200 is provided, for example, between the first base portion 11 and the second base portion 12. The controller 200 is held by, for example, the holding surface 210f.

The controller 200 is electrically connected to, for example, the first semiconductor light emitting unit 61 and the second semiconductor light emitting unit 62. For example, the controller 200 controls the current supplied to the first semiconductor light emitting unit 61. For example, the controller 200 controls the current supplied to the second semiconductor light emitting unit 62. For example, the operations (ON and OFF, brightness, etc.) of multiple semiconductor light emitting units (the first semiconductor light emitting unit 61 and the second semiconductor light emitting unit 62) are controlled by the controller 200.

For example, the chassis of the illumination device opens out from the base portion toward the light-transmissive member. The configuration of the chassis is, for example, a trapezoid. In such a case, when the illumination devices are multiply disposed in the illumination unit, a space is defined by the illumination devices. The space is defined by, for example, the mutually-opposing side portions (e.g., the first side portion 21 and the sixth side portion 26) and the holding surface 210f. For example, the controller 200 may be disposed in the space. Also, for example, mounting jigs, terminal blocks, etc., may be disposed in the space. Thereby, shielding of the light from the semiconductor light emitting unit by the controller 200, etc., can be suppressed; and a uniform light emission can be obtained in the illumination unit. Also, the external appearance of the illumination unit is good.

The configurations of the first side surface 211 and the second side surface 212 may match the configurations of the chassis. For example, in the case where the configurations of the chassis are trapezoids, a protruding portion (e.g., a first protruding portion 211p) may be provided at portions of the first side surface 211 and the second side surface 212. The tip of the protruding portion is disposed, for example, between the first illumination device 111 and the second illumination device 112. When the illumination devices are held by the holder 210, at least a portion of the light-transmissive members may protrude from the first side surface 211 and the second side surface 212.

For example, the first side surface 211 and the second side surface 212 include receptacle connectors 213. For example, the receptacle connectors 213 are multiply provided. For example, the connection terminals (e.g., the first connection terminal 91 and the second connection terminal 92) of the illumination devices are connected to the receptacle connectors 213. For example, the receptacle connectors 213 are connected mechanically to the connection terminals. For example, the illumination devices may be held by the holder 210 by the connections between the connection terminals and the receptacle connectors 213. For example, the connection terminals may have protruding configurations (e.g., pin configurations); the receptacle connectors may have recessed configurations; and the connection terminals may fit into the receptacle connectors. For example, the receptacle connectors 213 are electrically connected to the connection terminals. The connection terminals are electrically connected to the controller 200 via, for example, the holder 210.

The receptacle connectors 213 are electrically connected to, for example, the controller 200. Therefore, the controller 200 is electrically connected to the semiconductor light emitting units (e.g., the first semiconductor light emitting unit 61 and the second semiconductor light emitting unit 62) of the illumination devices by connecting the connection terminals (e.g., the first connection terminal 91 and the second connection terminal 92) of the illumination devices to the receptacle connectors 213. Thereby, it is possible to supply power to the semiconductor light emitting unit 62 via the receptacle connector 213.

The holder 210 includes, for example, a plastic or a metal. The receptacle connector 213 includes, for example, a metal. Only the receptacle connector 213 of the holder 210 may include a different material. For example, a metal may be used as the receptacle connector 213; and a plastic may be used as the portions of the holder 210 other than the receptacle connector 213.

In the illumination unit 311, multiple (in the example, two) illumination devices that emit light uniformly are held by the holder 210. Therefore, a uniform light emission can be obtained over the entire region of the illumination unit 311. For example, the connection terminals (e.g., the first connection terminal 91 and the second connection terminal 92) are provided respectively in the illumination devices; and the connection terminals are connected respectively to the receptacle connectors 213 of the holder 210. That is, in the illumination unit 311, each of the multiple illumination devices is held by the holder 210 in an independent state. Therefore, in the case where a discrepancy occurs in one illumination device of the multiple illumination devices included in the illumination unit 311, only the illumination device that has the discrepancy can be removed. Further, in the illumination unit 311, the controller 200 can be electrically connected to the receptacle connectors 213; and it is possible to supply power to the multiple illumination devices via the receptacle connectors 213. Therefore, a complex wiring operation is unnecessary; and the wiring operation is easy.

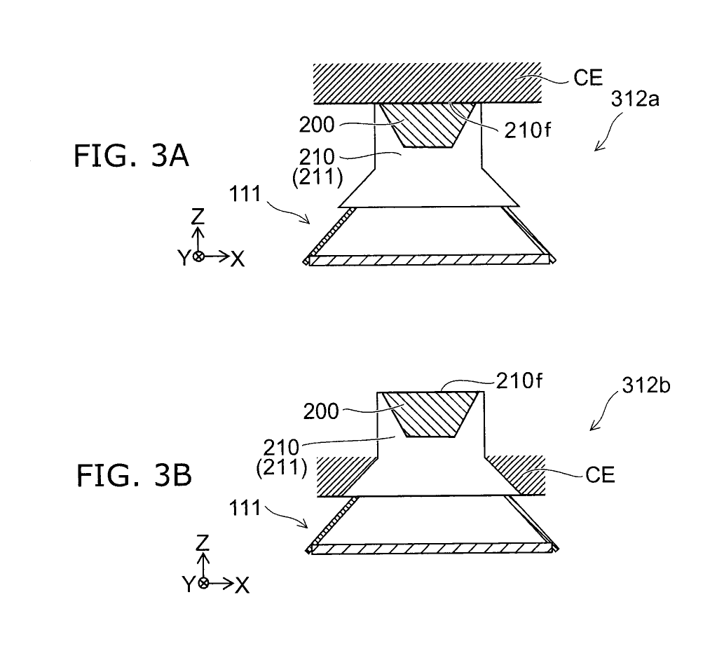

FIG. 3A and FIG. 3B are schematic cross-sectional views illustrating illumination units according to the first embodiment. FIG. 3A and FIG. 3B correspond to the cross-sectional view along line A1-A2 of FIG. 1B.

FIG. 3A shows an example of an illumination unit directly mounted to the ceiling. FIG. 3B shows an example of an illumination unit sunk into the ceiling. In the example, the illumination unit includes one illumination device. The illumination device described in regard to FIG. 1A to FIG. 1B may be used in the illumination unit. In FIG. 3A and FIG. 3B, the controller 200 is shown in a see-through view.

In the example as shown in FIG. 3A and FIG. 3B, the controller 200 is held by the holding surface 210f. For example, the illumination device 111 is held by the holder 210 by being connected to the receptacle connector 213 by the first connection terminal 91.

In an illumination unit 312a as shown in FIG. 3A, for example, the holding surface 210f is disposed between a ceiling CE and the controller 200. The mounting of the illumination unit 312a is easy.

In an illumination unit 312b as shown in FIG. 3B, for example, the holder 210 is sunk into the ceiling CE. The external appearance of the illumination unit 312b is good.

A uniform light emission can be obtained in the illumination units 312a and 312b.

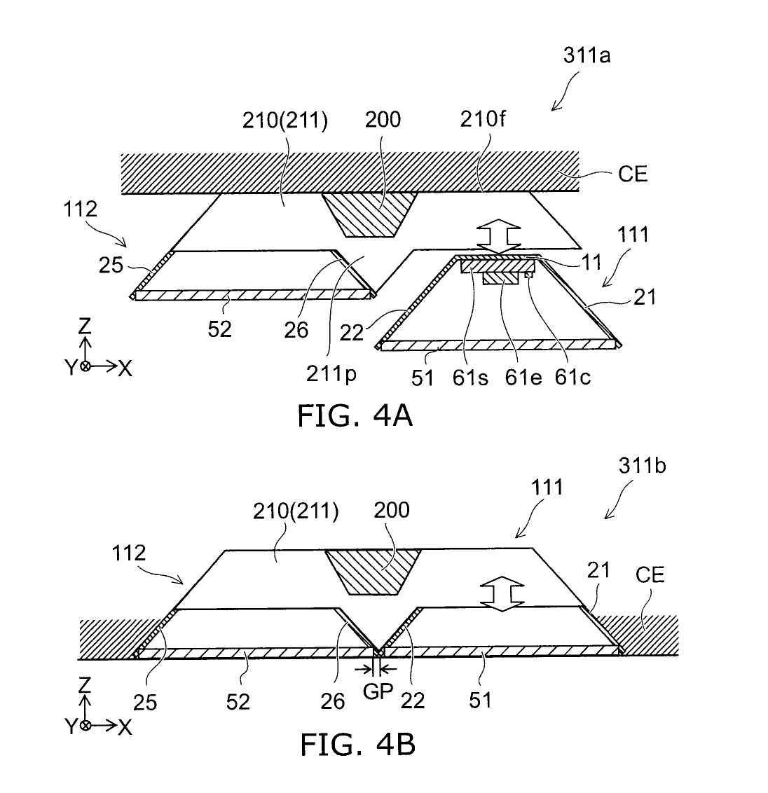

FIG. 4A and FIG. 4B are schematic cross-sectional views illustrating illumination units according to the first embodiment. FIG. 4A and FIG. 4B show cross-sectional views projected onto the X-Z plane.

FIG. 4A shows an example of an illumination unit directly mounted to the ceiling. FIG. 4B shows an example of an illumination unit sunk into the ceiling. In FIG. 4A and FIG. 4B as well, the controller 200 is shown in a see-through view.

The illumination unit 311a and the illumination unit 311b include the first illumination device 111 and the first illumination device 112, respectively. The illumination device described in regard to FIG. 2 is applicable to the first illumination device 111 and the second illumination device 112.

In the illumination unit 311a as shown in FIG. 4A, for example, the holder 210 is disposed between the ceiling CE and the first illumination device 111 and between the ceiling CE and the second illumination device 112.

In the illumination unit 311b as shown in FIG. 4B, for example, the holder 210 is sunk into the ceiling CE.

A gap GP is provided between the first light-transmissive member 51 and the second light-transmissive member 52 for the illumination unit 311a and the illumination unit 311b. For example, air enters the interior of the illumination unit through the gap GP. The heat dissipation of the first illumination device 111 and the second illumination device 112 is promoted. For example, the gap GP functions as a vent hole.

On the other hand, in the case where the width of the gap GP (the distance between the first light-transmissive member 51 and the second light-transmissive member 52 in the plane perpendicular to the second direction (the Z-axis direction)) is too large, the gap GP becomes a non-light emitting region; and the illumination unit does not have a uniform light emission as an entirety. The width of the gap GP is, for example, not less than 0.1 mm and not more than 2 mm.

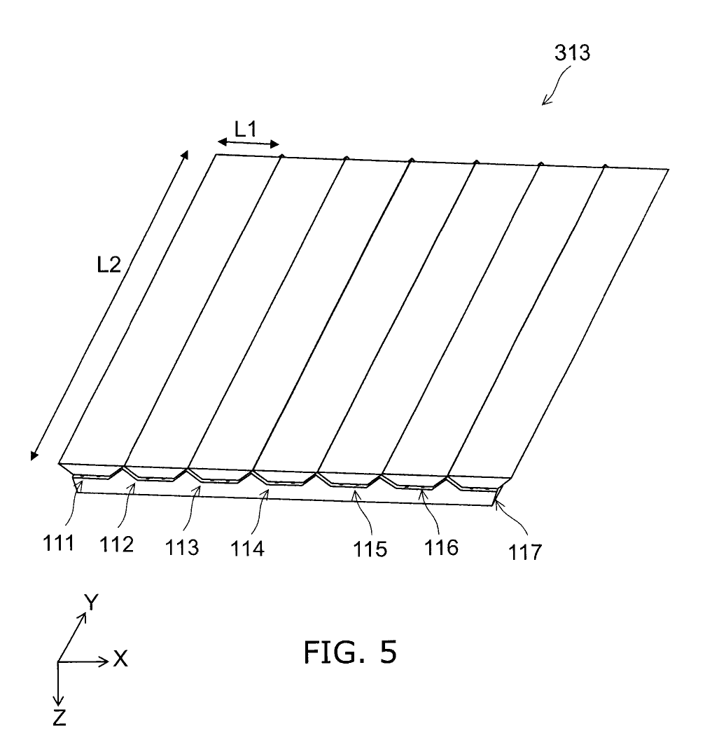

FIG. 5 is a perspective view illustrating an illumination unit according to the first embodiment.

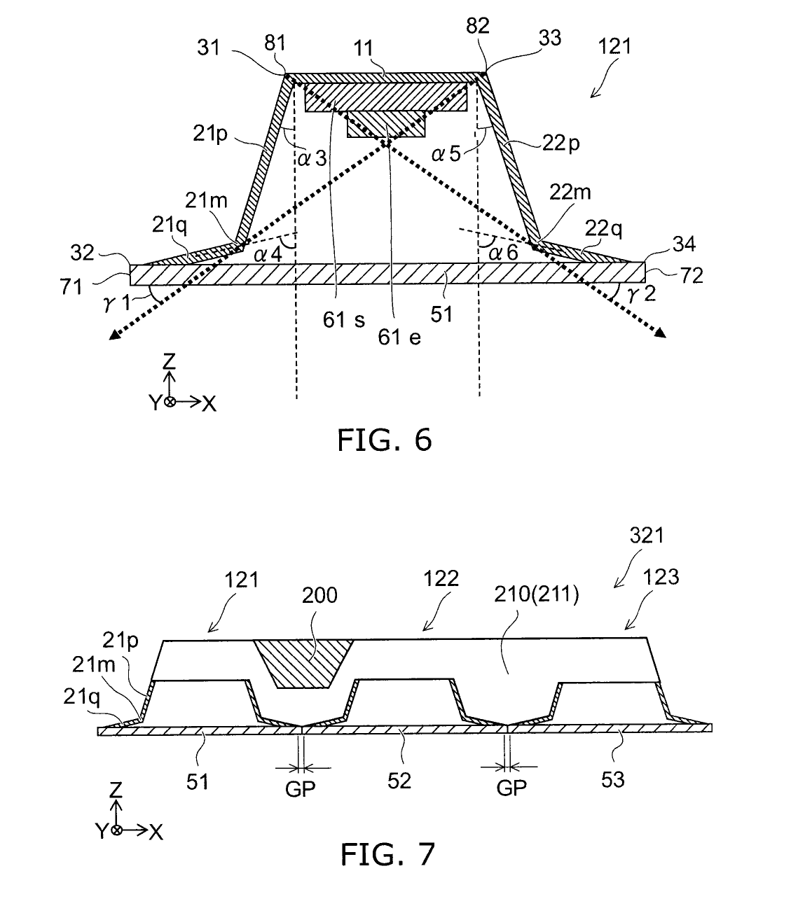

In the example, the illumination unit 313 includes seven illumination devices (the first illumination device 111 to the seventh illumination device 117). The illumination device described in regard to FIG. 1A to FIG. 1B may be used as the illumination devices. Also, the illumination device relating to FIG. 6 described below may be used.

In the example, in the illumination unit 313, the configurations of the illumination devices are rectangles. A length L1 of the short side of the rectangle of each of the illumination devices is, for example, about 86 mm. A length L2 of the long side of the rectangle of each of the illumination devices is, for example, about 600 mm. In the example, the seven illumination devices are arranged in the short-side direction. In the example, the length of the illumination unit 313 along the length L1 is about 602 mm. The illumination unit 313 provides, for example, square illumination.

### Second Embodiment

FIG. 6 is a schematic cross-sectional view illustrating an illumination device according to a second embodiment. FIG. 6 shows a cross-sectional view projected onto the X-Z plane.

In the illumination device 121 according to the embodiment, the first side portion 21 further has a first middle portion 21m. The second side portion 22 further has a second middle portion 22m. Otherwise, the configuration of the illumination device described in regard to FIG. 1A to FIG. 1C is applicable.

For example, the first middle portion 21m is provided between the first end portion 31 and the second end portion 32. When projected onto the first plane including the first direction and the second direction, an angle α3 between the second direction (the Z-axis direction) and the line segment connecting the first end portion 31 to the first middle portion 21m is smaller than an angle α4 between the second direction and the line segment connecting the first middle portion 21m to the second end portion 32.

For example, the second middle portion 22m is provided between the third end portion 33 and the fourth end portion 34. When projected onto the first plane, an angle α5 between the second direction and the line segment connecting the third end portion 33 to the second middle portion 22m is smaller than an angle α6 between the second direction and the line segment connecting the second middle portion 22m to the fourth end portion 34.

For example, the angle of the first side portion 21 changes at the first middle portion 21m. For example, the first middle portion 21m has a protruding configuration protruding toward the first inner surface 21a side. The first middle portion 21m may have, for example, a curved configuration.

In the example, the first side portion 21 has a first portion 21p provided between the first end portion 31 and the first middle portion 21m, and a second portion 21q provided between the first middle portion 21m and the second end portion 32. The configuration of the first portion 21p is, for example, a rectangle having a long side extending in the third direction. For example, the configuration of the second portion 21q is a rectangle having a long side extending in the third direction.

For example, the angle of the second side portion 22 changes at the second middle portion 22m. The second middle portion 22m has, for example, a protruding configuration protruding toward the second inner surface 22a side. The second middle portion 22m may have, for example, a curved configuration.

In the example, the second side portion 22 has a third portion 22p provided between the third end portion 33 and the second middle portion 22m, and a fourth portion 22q provided between the second middle portion 22m and the fourth end portion 34. The configuration of the third portion 22p is, for example, a rectangle having a long side extending in the third direction. The configuration of the fourth portion 22q is, for example, a rectangle having a long side extending in the third direction.

When projected onto the plane (e.g., the first plane) perpendicular to the third direction (the Y-axis direction), an angle γ1 between the first direction and the line segment connecting the third end portion 33 to the first middle portion 21m is, for example, not less than 25 degrees and not more than 45 degrees.

When projected onto the plane perpendicular to the third direction (the Y-axis direction), an angle γ2 between the first direction and the line segment connecting the first end portion 31 and the second middle portion 22m is, for example, not less than 25 degrees and not more than 45 degrees.

A uniform light emission is obtained in the illumination device 121. Also, good light shielding is obtained.

FIG. 7 is a schematic cross-sectional view illustrating an illumination unit according to the second embodiment. FIG. 7 shows a cross-sectional view projected onto the X-Z plane.

FIG. 7 shows an example of the illumination unit 321. In the example, the illumination unit 321 includes three illumination devices (the illumination devices 121 to 123). Other than the illumination device described in regard to FIG. 6 being used as the illumination devices of the illumination unit 321, the illumination unit 321 is similar to the illumination units described in regard to FIG. 2 to FIG. 5. In FIG. 7 as well, the controller 200 is shown in a see-through view.

In the illumination unit 321 as well, a uniform light emission can be obtained. In the illumination unit 321, for example, the space between the illumination devices can be wider because the first side portion 21 includes the first middle portion 21m, and the second side portion 22 includes the second middle portion 22m. The heat dissipation is good. Also, the glare is suppressed.

According to the embodiments, an illumination device and an illumination unit that emit light uniformly can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the illumination device and the illumination unit such as the light-transmissive member, the chassis, the semiconductor light emitting unit, the connection terminal, the holder, the receptacle connector, the controller, etc., from known art; and such practice is within the scope of the invention to the extent that similar effects are obtained.

Further, any two or more components of the specific examples may be combined within the extent of technical feasibility and are included in the scope of the invention to the extent that the purport of the invention is included.

Moreover, all illumination devices and illumination units practicable by an appropriate design modification by one skilled in the art based on the illumination devices and the illumination units described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An illumination device, comprising:
a first light-transmissive member having a first member end and a second member end, the second member end being separated from the first member end in a first direction;
a first chassis including
a first base portion separated from the first light-transmissive member in a second direction intersecting the first direction, the first base portion having a first base end and a second base end, the second base end being separated from the first base end in the first direction,
a first side portion extending from the first base end toward the first member end, the first side portion having a first end portion and a second end portion, the first end portion being connected to the first base end, the second end portion being on a side of the first member end, and
a second side portion extending from the second base end toward the second member end, the second side portion having a third end portion and a fourth end portion, the third end portion being connected to the second base end, the fourth end portion being on a side of the second member end,
a distance along the first direction between the first end portion and the third end portion being shorter than a distance along the first direction between the second end portion and the fourth end portion; and
a first semiconductor light emitting unit provided between the first side portion and the second side portion in a space between the first light-transmissive member and the first base portion.

2. The device according to claim 1, wherein
an angle between the second direction and a line segment connecting the first end portion to the second end portion is more than 0 degrees but less than 90 degrees, and
an angle between the second direction and a line segment connecting the third end portion to the fourth end portion is more than 0 degrees but less than 90 degrees.

3. The device according to claim 1, further comprising a first connection terminal electrically connected to the first semiconductor light emitting unit,
the first light-transmissive member further having a third member end connected to one end of the first member end and one end of the second member end,
the first base portion further having a third base end connected to one end of the first base end and one end of the second base end,
the first chassis further including a third side portion provided between the third base end and the third member end, the third side portion intersecting a third direction intersecting the first direction and the second direction,
the first connection terminal piercing the third side portion in the third direction.

4. The device according to claim 3, wherein a configuration of the first base portion is a rectangle having the first base end and the second base end as long sides of the rectangle and the third base end and the fourth base end as short sides of the rectangle when projected onto a plane perpendicular to the third direction.

5. The device according to claim 3, wherein a configuration of the illumination device is a trapezoid formed by the first base portion, the first side portion, the second side portion, and the first light-transmissive member when projected onto a plane perpendicular to the third direction.

6. The device according to claim 3, wherein
a first angle between the first direction and a line segment connecting the second end portion to the third end portion is not less than 15 degrees and not more than 45 degrees when projected onto a plane perpendicular to the third direction, and
a second angle between the first direction and a line segment connecting the first end portion to the fourth end portion is not less than 15 degrees and not more than 45 when projected onto the plane.

7. The device according to claim 6, wherein the first angle is same as the second angle.

8. The device according to claim 1, wherein
an angle between the first base portion and the first side portion is not less than 45 degrees and not more than 75 degrees, and
an angle between the first base portion and the second side portion is not less than 45 degrees and not more than 75 degrees.

9. The device according to claim 1, wherein a thermal conductivity of the first chassis is higher than a thermal conductivity of the first light-transmissive member.

10. The device according to claim 1, wherein the first base portion, the first side portion, and the second side portion includes a metal.

11. The device according to claim 10, wherein the first light-transmissive member includes at least one of a plastic plate being light-transmissive and a glass plate being light-transmissive.

12. The device according to claim 3, wherein
the first side portion further has a first middle portion provided between the first end portion and the second end portion,
an angle between the second direction and a line segment connecting the first end portion to the first middle portion is smaller than an angle between the second direction and a line segment connecting the first middle portion to the second end portion,
the second side portion further has a second middle portion provided between the third end portion and the fourth end portion, and
an angle between the second direction and a line segment connecting the third end portion to the second middle portion is smaller than an angle between the second direction and a line segment connecting the second middle portion to the fourth end portion.

13. The device according to claim 12, wherein
an angle between the first direction and a line segment connecting the third end portion to the first middle portion is not less than 25 degrees and not more than 45 degrees when projected onto a plane perpendicular to the third direction, and
an angle between the first direction and a line segment connecting the first end portion to the second middle portion is, not less than 25 degrees and not more than 45 degrees when projected onto the plane.

14. The device according to claim 1, wherein
the first side portion has a first inner surface on a side of the second side portion,
the second side portion has a second inner surface on a side of the first side portion,
a reflectance of at least a portion of the first inner surface is higher than a reflectance of the first light-transmissive member, and
a reflectance of at least a portion of the second inner surface is higher than the reflectance of the first light-transmissive member.

15. The device according to claim 14, wherein
the first side portion has a first outer surface on a side opposite to the first inner surface,
the second side portion has a second outer surface on a side opposite to the second inner surface,
an emissivity of at least a portion of the first outer surface is higher than an emissivity of the first light-transmissive member, and
an emissivity of at least a portion of the second outer surface is higher than the emissivity of the first light-transmissive member.

16. An illumination unit, comprising:
a first illumination device including
a first light-transmissive member having a first member end and a second member end, the second member end being separated from the first member end in a first direction,
a first chassis including a first base portion, a first side portion, and a second side portion, the first base portion being separated from the first light-transmissive member in a second direction intersecting the first direction, the first base portion having a first base end and a second base end, the second base end being separated from the first base end in the first direction, the first side portion being provided to extend from the first base end toward the first member end, the first side portion having a first end portion and a second end portion, the first end portion being connected to the first base end, the second end portion being on a side of the first member end, the second side portion being provided to extend from the second base end toward the second member end, the second side portion having a third end portion and a fourth end portion, the third end portion being connected to the second base end, the fourth end portion being on a side of the second member end, a distance along the first direction between the first end portion and the third end portion being shorter than a distance along the first direction between the second end portion and the fourth end portion, and
a first semiconductor light emitting unit provided between the first side portion and the second side portion in a space between the first light-transmissive member and the first base portion;
a controller electrically connected to the first semiconductor light emitting unit, the controller being configured to control a current supplied to the first semiconductor light emitting unit; and
a holder configured to hold the first illumination device.

17. The illumination unit according to claim 16, wherein
the first illumination device further includes a first connection terminal electrically connected to the first semiconductor light emitting unit,
the first light-transmissive member further has a third member end connected to one end of the first member end and one end of the second member end,
the first base portion further has a third base end connected to one end of the first base end and one end of the second base end,
the first chassis further includes a third side portion provided between the third base end and the third member end to intersect a third direction intersecting the second direction and intersecting the first direction, and
the first connection terminal pierces the third side portion in the third direction.

18. The illumination unit according to claim 17, wherein the first connection terminal is electrically connected to the controller via the holder.

19. The illumination unit according to claim 16, further comprising:
a second illumination device including
a second light-transmissive member having a fifth member end and a sixth member end, the sixth member end being separated from the fifth member end in a first direction,
a second chassis including a second base portion, a fifth side portion, and a sixth side portion, the second base portion being separated from the second light-transmissive member in the second direction, the second base portion having a fifth base end and a sixth base end, the sixth base end being provided between the first base end and the fifth base end in a space between the second base end and the fifth base end to be separated from the fifth base end in the first direction, the fifth side portion being provided to extend from the fifth base end toward the fifth member end, the fifth side portion having a fifth end portion and a sixth end portion, the fifth end portion being connected to the fifth base end, the sixth end portion being on the fifth member end side, the sixth side portion being provided to extend from the sixth base end toward the sixth member end, the sixth side portion having a seventh end portion and an eighth end portion, the seventh end portion being connected to the sixth base end, the eighth end portion being on the sixth member end side, a distance along the first direction between the fifth end portion and the seventh end portion being shorter than a distance along the first direction between the sixth end portion and the eighth end portion, and
a second semiconductor light emitting unit provided between the fifth side portion and the sixth side portion in a space between the second light-transmissive member and the second base portion,
the holder having a holding surface configured to hold the first base portion, the second base portion, and the controller,
the controller being electrically connected also to the second semiconductor light emitting unit and being further configured to control a current supplied to the second semiconductor light emitting unit, and
the controller being disposed in a space defined by the first base end, the sixth base end, and the holding surface.

20. The illumination unit according to claim 19, wherein a gap between the first light-transmissive member and the second light-transmissive member is not less than 0.1 millimeters and not more than 2 millimeters.
